(19) United States
(12) Patent Application Publication
(10) Pub. No.: US 2013/0189603 A1
(43) Pub. Date: Jul. 25, 2013

(54) FUEL CELL

(71) Applicants: Tomokazu Sakamoto, Gamo-gun (JP); Koichiro Asazawa, Gamo-gun (JP); Koji Yamada, Gamo-gun (JP); Hirohisa Tanaka, Gamo-gun (JP)

(72) Inventors: Tomokazu Sakamoto, Gamo-gun (JP); Koichiro Asazawa, Gamo-gun (JP); Koji Yamada, Gamo-gun (JP); Hirohisa Tanaka, Gamo-gun (JP)

(73) Assignee: DAIHATSU MOTOR CO., LTD.

(21) Appl. No.: 13/876,626

(22) PCT Filed: Sep. 9, 2011
(86) PCT No.: PCT/JP2011/005064

§ 371 Date: Mar. 28, 2013

(30) Foreign Application Priority Data
Oct. 27, 2010 (JP) 2010-241273

(51) Int. Cl. H01M 4/90; H01M 8/10

(52) U.S. Cl. CPC H01M 4/9041; H01M 8/10
USPC 429/485

(57) ABSTRACT

[Problem] To provide a fuel cell having excellent power generation performance, which includes a compound containing at least hydrogen and nitrogen as fuel and uses an anion exchange membrane as an electrolyte layer. [Solution] In a fuel cell 1 including an electrolyte layer 4 formed from an anion exchange membrane, a fuel side electrode 2 and an oxygen side electrode 3, both electrodes being disposed to face each other with the electrolyte layer 4 interposed therebetween, the fuel side electrode 2 contains lanthanum and nickel as a metal catalyst such that the content proportion of lanthanum is 10 to 30% relative to the total mole of the lanthanum and nickel. Further, a compound containing at least hydrogen and nitrogen, such as hydrazine, is used as fuel.

### TECHNICAL FIELD

The present invention relates to a fuel cell, and more particularly to a polymer electrolyte fuel cell.

### BACKGROUND ART

Various fuel cells such as an alkali type (AFC), a polymer electrolyte type (PEFC), phosphoric aid type (PAFC), a molten carbonate type (MCFC), and a solid oxide type (SOFC) are currently known. Among these fuel cells, a polymer electrolyte fuel cell can be driven at relatively low temperature, so that use in various applications such as automobiles has been examined.

As one example of the polymer electrolyte fuel cells, a fuel cell has been proposed which includes an electrolyte layer including an anion exchange membrane, a fuel side electrode containing cobalt and nickel and to which fuel of a compound containing hydrogen and nitrogen (such as hydrazine) is supplied, and an oxygen side electrode to which oxygen is supplied, the electrodes being disposed to face each other (for example, see Patent Document 1).

As disclosed in Patent Document 1, the fuel cell containing cobalt and nickel in the fuel side electrode can have higher power generation performance, for example, than that containing only cobalt in the fuel side electrode.

On the other hand, when a fuel cell which uses a compound containing hydrogen and nitrogen, such as hydrazine, as fuel has a fuel side electrode containing cobalt and nickel, side reaction occurs; for example, hydrazine is decomposed into ammonia. As a result, it in known that deterioration in use efficiency of fuel is caused (for example, see Non-Patent Document 1).

### CITATION LIST

### Patent Document

Patent Document 1: JP-A-2010-225471

### Non-Patent Document

Non-Patent Document 1: Journal of Electrochemical Society, 2009, 156(4), B509-B512

### DISCLOSURE OF THE INVENTION

### Problems to be Solved by the Invention

As described above, although the fuel side electrode containing cobalt and nickel can improve the power generation performance, the fuel cannot be used at sufficient efficiency. This may result in failure of securing sufficient power generation performance.

For this reason, in recent years, a further improvement in power generation performance of fuel cells has been desired.

In view of this, it is an object of the present invention to provide a fuel cell having excellent power generation performance, which includes a compound containing at least hydrogen and nitrogen as fuel and uses an anion exchange membrane as an electrolyte layer.

### Solutions to the Problems

For the purpose of attaining the above object, a fuel cell according to the present invention is a fuel cell comprising an electrolyte layer, a fuel side electrode to which fuel is supplied, and an oxygen side electrode to which oxygen is supplied, the fuel side electrode and the oxygen side electrode being disposed to face each other with the electrolyte layer interposed therebetween, wherein the electrolyte layer is an anion exchange membrane; the fuel includes a compound containing at least hydrogen and nitrogen; the fuel side electrode contains lanthanum and nickel; and the fuel side electrode contains lanthanum at a proportion of 10 to 30 mol % relative to the total mole of lanthanum and nickel.

Moreover, in the fuel cell according to the present invention, the fuel is preferably hydrazines.

### Effects of the Invention

According to the fuel cell of the present invention, lanthanum and nickel are contained in the fuel side electrode. The content proportion of lanthanum in the fuel side electrode is 10 to 30% relative to the total mole of the lanthanum and nickel. Therefore, unlike in the case where the fuel side electrode contains cobalt and nickel, the decomposition of the fuel through side reaction is suppressed, thereby improving the use efficiency of the fuel. This results in the improvement of power generation performance.

### BRIEF DESCRIPTION OF THE DRAWINGS

FIG. 1 is a schematic configuration diagram depicting one embodiment of a fuel cell of the present invention.

FIG. 2 is a graph expressing results of measuring the activities of fuel side electrodes.

### DESCRIPTION OF EMBODIMENTS

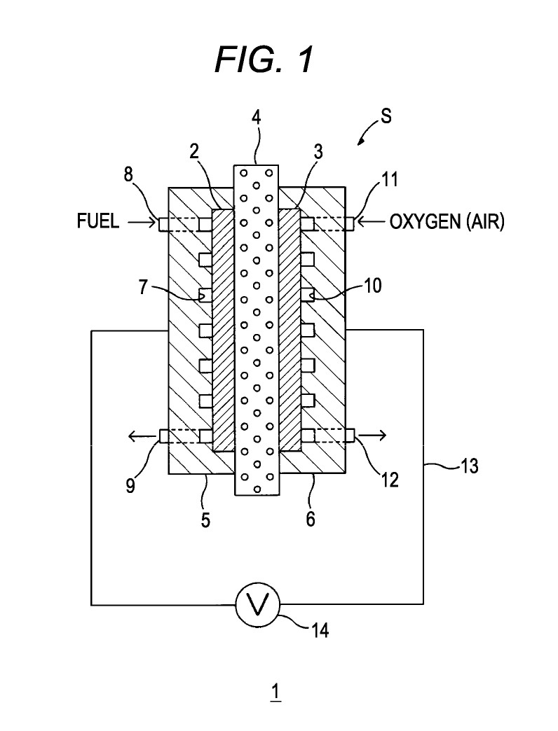

FIG. 1 is a schematic configuration diagram depicting one embodiment of a fuel cell of the present invention. In FIG. 1, a fuel cell 1 includes a cell S for fuel cell. The cell S for fuel cell includes a fuel side electrode 2, an oxygen side electrode 3, and an electrolyte layer 4. The fuel side electrode 2 and the oxygen side electrode 3 are disposed to face each other with the electrolyte layer 4 interposed therebetween.

The fuel side electrode 2 faces one surface of the electrolyte layer 4 and is in contact therewith. This fuel side electrode 2 contains lanthanum (La) and nickel (Ni) as a metal catalyst.

Specific examples of the metal catalyst include a mixture (mixture catalyst) of lanthanum and nickel, an alloy of lanthanum and nickel (lanthanum-nickel alloy), and a mixture of lanthanum, nickel, and a lanthanum-nickel alloy.

The metal catalyst in such an aspect is produced by, for example, preparing a dispersion liquid including a lanthanum salt and a nickel salt first, drying lanthanum and nickel, and then firing.

More specifically, the metal catalyst is produced by, for example, dispersing a lanthanum salt and a nickel salt in a solvent to prepare a dispersion liquid.

Examples of the lanthanum salt include an inorganic metal salt of lanthanum and an organic metal salt of lanthanum.

Examples of the inorganic metal salt of lanthanum include inorganic acid salts such as sulfate, nitrate, and phosphate (for example, chlorides and ammonium salts).

Examples of the organic metal salt of lanthanum include carboxylate of lanthanum such as lanthanum acetate or lanthanum propionate, a β-diketone compound or a β-keto ester compound represented by the following general formula (1), and/or a metal chelate complex of lanthanum including a β-dicarboxylate compound represented by the following general formula (2):

R₁COCHR₃COR₂ (1)

(wherein, R1 represents an alkyl group with a carbon number of 1 to 6 or a fluoroalkyl group or an aryl group with a carbon number of 1 to 6, R2 represents an alkyl group with a carbon number of 1 to 6, a fluoroalkyl group or aryl group with a carbon number of 1 to 6, or an alkoxy group with a carbon number of 1 to 4, and R3 represents a hydrogen atom or an alkyl group with a carbon number of 1 to 4);

R₅CH(COR₄)₂ (2)

(wherein, R4 represents an alkyl group with a carbon number of 1 to 6, and R5 represents a hydrogen atom or an alkyl group with a carbon number of 1 to 4).

Examples of the alkyl group with a carbon number of 1 to 6 as R1, R2, and R4 in the general formula (1) and the general formula (2) include methyl, ethyl, propyl, isopropyl, n-butyl, s-butyl, t-butyl, a-amyl, and t-hexyl. Examples of the alkyl group with a carbon number of 1 to 4 as R3 and R5 include methyl, ethyl, propyl, isopropyl, n-butyl, s-butyl, and t-butyl.

An example of the fluoroalkyl group with a carbon number of 1 to 6 as R1 and R2 in the general formula (1) is trifluoromethyl. An example of the aryl group as R1 and R2 is a phenyl group. Examples of the alkoxy group with a carbon number of 1 to 4 as R1 include methoxy, ethoxy, propoxy, isopropoxy, n-butoxy, s-butoxy, t-butoxy, and the like.

More specifically, examples of the β-diketone compound include 2,4-pentanedione, 2,4-hexanedione, 2,2-dimethyl-3,5-hexanedione, 1-phenyl-1,3-butanedione, 1-trifluoromethyl-1,3-butanedione, hexafluoroacetylacetone, 1,3-diphenyl-1,3-propanedione, and dipivaloylmethane.

More specifically, examples of the β-keto ester compound include methyl acetoacetate, ethyl acetoacetate, and t-butyl acetoacetate.

More specifically, examples of the β-dicarboxylate compound include dimethyl malonate and diethyl malonate.

Any of these lanthanum salts can be used alone or two or more kinds thereof can be used in combination.

The lanthanum salt is preferably an inorganic metal salt of lanthanum, and more preferably an inorganic acid salt of lanthanum.

Examples of the nickel salt include an inorganic metal salt of nickel and an organic metal salt of nickel.

Examples of the inorganic metal salt of nickel include inorganic acid salts such as sulfate, nitrate, and phosphate; for example, a chloride, an ammonium salt, and the like are given.

Examples of the organic metal salt of nickel include carboxylate of nickel such as nickel acetate or nickel propionate, a β-diketone compound or a β-keto ester compound represented by the above general formula (1), and/or a metal chelate complex of nickel including a β-dicarboxylate compound represented by the above general formula (2).

Any of these nickel salts may be used alone or two or more kinds thereof may be used in combination.

The nickel salt is preferably an inorganic metal salt of nickel, and more preferably an inorganic acid salt of nickel.

Examples of the solvent include water, alcohols (such as 2-propanol), ethers (such as tetrahydrofurane (THF)), ketones, esters, aliphatic hydrocarbons, and aromatic hydrocarbons.

Any of these solvents may be used alone or two or more kinds thereof may be used in combination.

Preferred examples of the solvent include water, alcohols, and ethers.

The dispersion liquid can be prepared by, for example, a method of mixing the lanthanum salt and the nickel salt in the solvent, or a method of mixing a mixture of the lanthanum salt and the solvent and a mixture of the nickel salt and the solvent. Preferably, the dispersion liquid is prepared by the method of mixing a mixture of the lanthanum salt and the solvent and a mixture of the nickel salt and the solvent.

In such cases, the concentration of the lanthanum salt in the mixture of the lanthanum salt and the solvent is, for example, 0.0001 to 1 mol/L, and preferably 0.01 to 0.1 mol/L. Moreover, the concentration of the nickel salt in the mixture of the nickel salt and the solvent is, for example, 0.0001 to 1 mol/L, and preferably 0.01 to 0.1 mol/L.

In the dispersion liquid obtained by mixing those (mixture of the lanthanum salt, the nickel salt, and the solvent), the concentration (total amount) of the lanthanum salt and the nickel salt is, for example, 0.0001 to 1 mol/L, and preferably 0.01 to 0.1 mol/L.

Next, in this method, the solvent is removed from the obtained dispersion liquid by a known method such as heated-air drying or vacuum freeze drying, thereby drying, preferably vacuum freeze drying, the compound containing lanthanum and nickel.

More specifically, in the vacuum freeze drying, first, the dispersion liquid is cooled, for example, at −200 to 0° C., and preferably −196 to −100° C., and, for example, for 5 to 120 minutes, and preferably 20 to 40 minutes, thereby freezing (preliminarily freezing) the liquid.

Next, the solvent is sublimed from the frozen product under a vacuum condition (specifically, for example, 0.1 to 100 Pa), thereby providing a dried product. Note that the solvent is sublimed when the frozen product is placed under the vacuum condition. On this occasion, a temperature condition may be adjusted (heating or cooling) as necessary. For adjusting the temperature, the temperature condition is appropriately set as necessary.

Next, in this method, the obtained dried product is fired under a reducing atmosphere (for example, H₂/Ar mixture gas).

In the firing, the dried product is, for example, heated gradually and intermittently. In such a case, a temperature increasing speed at the heating time is set, for example, 0.1 to 20° C./minute, and preferably 1 to 12° C./minute. The maximum attainment temperature is, for example, 200 to 1200° C., and preferably 600 to 900° C., and the time for which the maximum attainment temperature is kept is, for example, 30 to 600 minutes, and preferably 180 to 360 minutes.

Thus, the metal catalyst containing lanthanum and nickel can be obtained.

As the metal catalyst, for example, a mixture obtained by mixing a fine powder of lanthanum metal obtained as a commercial product, a fine powder of nickel metal obtained as a commercial product, and, if necessary, a fine powder of a lanthanum-nickel alloy obtained as a commercial product can be used.

Lanthanum (a lanthanum metal atom) and nickel (a nickel metal atom) are necessarily contained in the metal catalyst, and the content proportions thereof are indicated as follows. That is, the content of the lanthanum (including lanthanum contained in the lanthanum-nickel alloy) is 10 to 30 mol %, preferably 10 to 20 mol %, and more preferably 10 to 15 mol % relative to the total mole of the lanthanum and nickel. The content of the nickel (including nickel contained in the lanthanum-nickel alloy) is 70 to 90 mol %, preferably 80 to 90 mol %, and more preferably 75 to 90 mol % relative to the total mole of the lanthanum and nickel.

As long as lanthanum is contained in the above proportion, excellent power generation performance can be achieved.

Note that the metal catalyst containing lanthanum and nickel at the proportions in the above range can be produced by, for example, adjusting the mixing proportions of lanthanum and nickel in the aforementioned method for producing the metal catalyst.

More specifically, in the method of producing the metal catalyst, the lanthanum salt and the nickel salt are mixed so that the molar number of the lanthanum (lanthanum metal atom) contained in the lanthanum salt satisfies the above proportion relative to the total mole of the lanthanum (lanthanum metal atom) contained in the lanthanum salt and the nickel (nickel metal atom) contained in the nickel salt.

Thus, the metal catalyst containing lanthanum and nickel at the proportions in the above range can be produced.

In the present invention, the lanthanum and nickel obtained in the above manner can be supported by carbon to produce the metal catalyst.

In the method for producing the metal catalyst, for allowing carbon to support the lanthanum and nickel, for example, a porous carbon support is mixed together with the lanthanum salt and the nickel salt.

When the carbon support is mixed, for example, uniform mixture of the solvent and the carbon support may be difficult. In such cases, for example, alcohols (such as ethanol) may be mixed together with the carbon support.

Note that in the case where lanthanum and nickel are supported by carbon, the lanthanum and nickel are used so that the lanthanum and nickel supported by the carbon is 0.1 to 50 wt %, and preferably 5 to 40 wt %, relative to the total amount of the lanthanum, nickel, and carbon.

The formation of the fuel side electrode 2 from such a metal catalyst is not particularly limited. However, for example, a membrane electrode assembly (MEA) is formed. That is, the MEA can be formed by a known method. For example, first, the above metal catalyst and an electrolyte solution are mixed. The viscosity is adjusted by adding an appropriate solvent such as alcohol to this mixture as necessary. Thus, a dispersion liquid for the above metal catalyst is prepared. Next, the above metal catalyst is fixed to a surface of the electrolyte layer 4 (anion exchange membrane) by coating the surface of the electrolyte layer 4 with the dispersion liquid.

The usage amount of the metal catalyst is, for example, 0.01 to 5 mg/cm².

On this fuel side electrode 2, as described later, a compound containing at least hydrogen and nitrogen to be supplied (hereinafter called “fuel compound”) and hydroxide ions (OH⁻) having passed through the electrolyte layer 4 react with each other to generate electrons (e⁻), nitrogen (N₂), and water (H₂O).

The oxygen side electrode 3 faces the other surface of the electrolyte layer 4 and is in contact therewith. This oxygen side electrode 3 is not particularly limited. However, the oxygen side electrode 3 may be formed as, for example, a porous electrode in which the catalyst is supported.

The catalyst is not particularly limited as long as the catalyst has a catalytic reaction for generating hydroxide ions (OH—) from oxygen (O₂) and water (H₂O) as described below. Examples of the catalyst include elements of Groups 8 to 10 (VIII) in the periodic table, such as platinum group metals (Ru, Rh, Pd, Os, Ir, and Pt) and iron group metals (Fe, Co, and Ni), elements of Group 11 (TB) in the period table such as Cu, Ag, and Au, and combinations thereof. Above all, the catalyst is preferably Co. The amount of supporting the catalyst is, for example, 0.1 to 10 mg/cm², and preferably 0.1 to 5 mg/cm². The catalyst is preferably supported by carbon.

The formation of the oxygen side electrode 3 from the catalyst is not particularly limited. However, the membrane electrode assembly is formed, for example, in a manner similar to the fuel side electrode 2.

In this oxygen side electrode 3, as described later, supplied oxygen (O₂), water (H₂O), and electrons (e⁻) having passed through an external circuit 13 react with one another to generate hydroxide ions (OH⁻).

The electrolyte layer 4 is formed from an anion exchange membrane. The anion exchange membrane is not particularly limited as long as the membrane is a medium that can transfer the hydroxide ions (OH³¹ ) generated from the oxygen side electrode 3 from the oxygen side electrode 3 to the fuel side electrode 2. Examples of the medium include a polymer electrolyte film (anion exchange resin) having an anion exchange group such as a quaternary ammonium group or a pyridinium group.

The cell S for fuel cell further includes a fuel supply member 5 and an oxygen supply member 6. The fuel supply member 5 includes a conductive member which does not transmit gas. One surface of the conductive member faces the fuel side electrode 2 and is in contact therewith. The fuel supply member 5 is provided with a fuel side flow path 7 which brings the fuel into contact with the entire fuel side electrode 2. That is, the fuel side flow path 7 is formed as a serpentine-shaped groove which is depressed from one surface of the fuel supply member 5. Note that a supply port 8 is formed at an upstream side end part of this fuel side flow path 7. An exhaust port 9 is formed at a downstream side end part of the fuel side flow path 7. The supply port 8 and the exhaust port 9 communicate with each other to penetrate through the fuel supply member 5.

The oxygen supply member 6 also includes a conductive member which does not transmit gas like the fuel supply member 5. One surface of the conductive member faces the oxygen side electrode 3 and is in contact therewith. This oxygen supply member 6 is also provided with an oxygen side flow path 10 which brings oxygen (air) into contact with the entire oxygen side electrode 3. That is, the oxygen side flow path 10 is formed as a serpentine-shaped groove which is depressed from one surface of the oxygen supply member 6. Note that a supply port 11 is formed at an upstream side end part of this oxygen side flow path 10. An exhaust port 12 is formed at a downstream side end part of the oxygen side flow path 10. The supply port 11 and the exhaust port 12 communicate with each other to penetrate through the oxygen supply member 6.

This fuel cell 1 is actually formed as a stack structure in which a plurality of the cells S for fuel cell is stacked. Therefore, in fact, the fuel supply member 5 and the oxygen supply member 6 are actually configured as one separator, and the fuel side flow path 7 and the oxygen side flow path 10 are formed on both surfaces of the separator.

This fuel cell 1 is provided with a current collector plate (not shown) formed using a conductive member. The current collector plate is configured so that an electromotive force generated from the fuel cell 1 is extracted to the outside from a terminal of the current collector plate.

Experimentally (in a model), the fuel supply member 5 and oxygen supply member 6 of this cell S for fuel cell are connected to each other via the external circuit 13. In this case, a voltage generated between the fuel supply member 5 and the oxygen supply member 6 can be measured by a voltmeter 14 placed in the external circuit 13.

In the present invention, the supply of the fuel including the fuel compound is performed directly not through a reformer or the like.

In this fuel compound, hydrogen is preferably directly bonded with nitrogen. The fuel compound preferably has a nitrogen-nitrogen bond, and preferably does not have a carbon-carbon bond. The carbon number thereof is preferably as small as possible (zero if possible).

The fuel compound may include an oxygen atom, a sulfur atom, or the like as long as the performance is not interrupted. More specifically, the oxygen atom or the sulfur atom may be contained in the fuel compound as, for example, a carbonyl group, a hydroxyl group, a hydrate, a sulfonate group, or sulfate.

From this viewpoint, specific examples of the fuel compound in the present invention include: hydrazines such as hydrazine (NH₂NH₂), hydrazine hydrate (NH₂NH₂.H₂O), hydrazine carbonate ((NH₂NH₂)₂CO₂), hydrazine sulfate (NH₂NH₂.H₂SO₄), monomethyl hydrazine (CH₃NHNH₂), dimethyl hydrazine ((CH₃)₂NNH₂, CH₃NHNHCH₃), and carbon hydrazide ((NHNH₂)₂CO); urea (NH₂CONH₂); ammonia (NH₃); heterocyclic compounds such as imidazole, 1,3,5-triazine, and 3-amino-1,2,4-triazole; and hydroxylamines such as hydroxylamine (NH₂OH) and hydroxylamine sulfate (NH₂OH.H₂SO₄). Any of these fuel compounds may be used alone or two or more kinds thereof may be used in combination. The fuel compound is preferably hydrazines.

Among the above fuel compounds, the compound without carbon such as hydrazine (NH₂NH₂), hydrazine hydrate (NH₂NH₂.H₂O), hydrazine sulfate (NH₂NH₂.H₂SO₄), ammonia (NH₃), hydroxylamine (NH₂OH), or hydroxylamine sulfate (NH₂OH.H₂SO₄) can improve the endurance because toxification of the catalyst from CO is not caused like in the hydrazine reaction as described later. Thus, substantially zero emission can be achieved.

As the fuel, the fuel compounds of the above examples may be used as they are. Alternatively, the fuel compounds of the above examples may be used after being contained in a solution such as water and/or alcohol (for example, lower alcohol such as methanol, ethanol, propanol or isopropanol). In this case, the concentration of the fuel compound in the solution depends on the kind of the fuel compound. For example, the concentration of the fuel compound in the solution is 1 to 90 wt %, and preferably 1 to 30 wt %.

As for the fuel, the fuel compound can be used as gas (for example, vapor).

The fuel is supplied to the fuel side flow path 7 of the fuel supply member 5 while oxygen (air) is supplied to the oxygen side flow path 10 of the oxygen supply member 6. In this case, as described next, electrons (e⁻) generated in the fuel side electrode 2 and moving via the external circuit 13, water (H₂O), and oxygen (O₂) react with one another in the oxygen side electrode 3, thereby generating hydroxide ions (OH⁻). The generated hydroxide ions (OH⁻) move from the oxygen side electrode 3 to the fuel side electrode 2 via the electrolyte layer 4 including the anion exchange membrane. In the fuel side electrode 2, the hydroxide ions (OH⁻) having passed through the electrolyte layer 4 react with the fuel to generate electrons (e⁻). The generated electrons (e⁻) are moved from the fuel supply member 5 to the oxygen supply member 6 via the external circuit 13, and further supplied to the oxygen side electrode 3. An electromotive force is generated through such an electrochemical reaction in the fuel side electrode 2 and the oxygen side electrode 3, so that power generation is performed.

Such an electrochemical reaction includes two kinds of reactions: one-stage reaction and two-stage reaction. In the one-stage reaction, the fuel directly reacts with the hydroxide ions (OH⁻) in the fuel side electrode 2. On the other hand, in the two-stage reaction, the fuel is decomposed into hydrogen (H₂) and nitrogen (N₂), and then the hydrogen (H₂) generated by the decomposition reacts with the hydroxide ions (OH⁻).

For example, when hydrazine (NH₂NH₂) is used as the fuel, the reaction at the fuel side electrode 2, the reaction at the oxygen side electrode 3, and the overall reaction in the one-stage reaction can be expressed as the following reaction formulae (1) to (3), respectively:

NH₂NH₂+4OH⁻→4H₂O+N₂+4e⁻(fuel side electrode); (1)

O₂+2H₂O+4e⁻→4OH⁻ (oxygen side electrode); and (2)

NH₂NH₂+O₂→2H₂O+N₂ (overall). (3)

In the two-stage reaction, the reaction at the fuel side electrode 2, the reaction at the oxygen side electrode 3, and the overall reaction can be expressed as the following reaction formulae (4) to (7):

NH₂NH₂→2H₂+N₂ (decomposition reaction: fuel side electrode); (4)

H₂+2OH⁻→2H₂O+2e⁻ (fuel side electrode); (5)

½O₂+H₂O+2e⁻→2OH⁻ (oxygen side electrode); and (6)

H₂+½O₂→H₂O (overall). (7)

As expressed by the reaction formula (4), hydrazine (NH₂NH₂) is decomposed in hydrogen (H₂) and nitrogen (N₂) once in the two-stage reaction; therefore, the decomposing reaction causes energy loss. Accordingly, when the proportion of the one-stage reaction is large relative to that of the two-stage reaction, a fuel usage efficiency is lowered and a heat generation amount increases. As a result, a deterioration in power generation performance becomes inevitable.

However, in this fuel cell 1, as aforementioned, lanthanum and nickel are necessarily contained as the metal catalyst in the fuel side electrode 2. The content proportion of lanthanum is 10 to 30 mol % relative to the total mole of lanthanum and nickel. This metal catalyst can suppress the decomposing reaction (decomposing reaction expressed by the formula (4)) of the fuel (hydrazine in the above example) to promote the direct reaction (reaction expressed by the formula (1)) relative to the hydroxide ions (OH⁻) of the fuel. Therefore, the fuel usage efficiency can be improved and the heat generation amount can be suppressed, and moreover the power generation performance can be improved.

An operation condition for this fuel cell 1 is not particularly limited. For example, in the operation condition for the fuel cell 1, pressure on the fuel side electrode 2 side is 200 kPa or less, and preferably 100 kPa or less, pressure on the oxygen side electrode 3 side is 200 kPa or less, and preferably 100 kPa or less, and the temperature of the cell S for fuel cell is 0 to 120° C., and preferably 20 to 80° C.

The description has been made on the embodiment of the present invention; however, the embodiment of the present invention is not limited thereto, and appropriate modifications can be made without departing from the gist of the present invention.

The fuel cell according to the present invention can be applied to, for example, a power source for driving motors in automobiles, ships, aircrafts, and the like, a power source for communication terminals such as mobile phones, and the like.

### EXAMPLES

The present invention will be described with reference to Examples and Comparative Examples below; however, the present invention is not limited by the following examples.

### Example 1

### Preparation of Metal Salt Solution

A metal salt solution below was prepared in an auto-sampler (manufactured by GILSON, Inc., GX-271 LH):

lanthanum nitrate (La(NO₃)₃) aqueous solution (concentration: 0.024 mol/L); and

nickel nitrate (Ni(NO₃)₂) aqueous solution (concentration: 0.045 mol/L).

### Preparation of Mixture Dispersion Liquid

In an auto-sampler (manufactured by GILSON, Inc., GX-271LH), 1.874 mL of lanthanum nitrate aqueous solution (4.5×10⁻⁵ mol in terms of lanthanum nitrate) and 8.994 mL of nickel nitrate aqueous solution (4.0×10⁻⁴ mol in terms of nickel nitrate) were mixed.

In the mixture solution, the total concentration of the metal salts, that is, the concentration (total amount) of lanthanum nitrate and nickel nitrate was 0.041 mol/L. As for the content proportions in the preparation, lanthanum was 10 mol % and nickel was 90 mol % relative to the total mole of the lanthanum and nickel (La:Ni=10:9 (molar ratio)).

Next, 0.1 g of a carbon support (manufactured by Lion Corporation, ECP-600JD) was mixed into the mixture solution. On this occasion, the weight proportion (total amount) of lanthanum and nickel was 30 wt % relative to the total amount of the carbon support, lanthanum, and nickel.

After that, a homogenizer (manufactured by TAITEC Co., Ltd., VP-050) was operated at an output of 10 to 20% to stir the mixed solution for approximately 3 minutes, thereby providing a dispersion liquid (slurry).

### Preliminary Freezing

The dispersion liquid was cooled for 30 minutes with liquid nitrogen (−196° C.) under atmospheric pressure, thereby freezing the liquid.

### Vacuum Freeze Drying

The temperature was adjusted according to a drying program shown in Table 1 using a vacuum freeze drier (manufactured by Labconco, FZ-12 type), thereby subliming the solvent from the dispersion liquid. Thus, a dried product was obtained.

TABLE 1

| | | decrease | keep | increase | keep | increase | keep | increase | keep | increase | keep |
|---|---|---|---|---|---|---|---|---|---|---|---|
| | | temper- | temper- | temper- | temper- | temper- | temper- | temper- | temper- | temper- | temper- |
| Step | start | ature | ature | ature | ature | ature | ature | ature | ature | ature | ature |
| temperature | room | −5 | −5 | 10 | 10 | 15 | 15 | 20 | 20 | 30 | 30 |
| (° C.) | temper- | | | | | | | | | | |
| | ature | | | | | | | | | | |
| temperature- | — | 1 | — | 1 | — | 1 | — | 1 | — | 1 | — |
| increasing/ | | | | | | | | | | | |
| temperature- | | | | | | | | | | | |
| decreasing | | | | | | | | | | | |
| speed | | | | | | | | | | | |
| (° C./minute) | | | | | | | | | | | |
| time | — | 0.25 | 300 | 0.25 | 300 | 0.08 | 600 | 0.08 | 600 | 0.17 | 10 |
| (minute) | | | | | | | | | | | |

### Firing

The dried product was fired in a gas-flow firing furnace (manufactured by Round Science Inc.) in the presence of a H₂/Ar mixture gas (H₂/Ar=10/90 (volume ratio)) while the temperature was adjusted according to a firing program shown in Table 2. Thus, a metal catalyst was obtained.

TABLE 2

| | | in- | | in- | | in- | | in- | | in- | | in- | in- | | |
|---|---|---|---|---|---|---|---|---|---|---|---|---|---|---|---|
| | | crease | keep | crease | keep | crease | keep | crease | keep | crease | keep | crease | crease | keep | |
| | | tem- | tem- | tem- | tem- | tem- | tem- | tem- | tem- | tem- | tem- | tem- | tem- | tem- | |
| | | per- | per- | per- | per- | per- | per- | per- | per- | per- | per- | per- | per- | per- | cool- |
| Step | start | ature | ature | ature | ature | ature | ature | ature | ature | ature | ature | ature | ature | ature | ing |
| temper- | room | 30 | 30 | 40 | 40 | 80 | 80 | 90 | 90 | 100 | 100 | 300 | 800 | 800 | 20 |
| ature | temper- | | | | | | | | | | | | | | |
| (° C.) | ature | | | | | | | | | | | | | | |
| temper- | — | 1 | — | 3 | — | 5 | — | 1 | — | 1 | — | 3.33 | 11.8 | — | 13 |
| ature- | | | | | | | | | | | | | | | |
| increasing/ | | | | | | | | | | | | | | | |
| temper- | | | | | | | | | | | | | | | |
| ature- | | | | | | | | | | | | | | | |
| decreasing | | | | | | | | | | | | | | | |
| speed | | | | | | | | | | | | | | | |
| (° C./ | | | | | | | | | | | | | | | |
| minute) | | | | | | | | | | | | | | | |
| time | — | 5 | 5 | 5 | 5 | 10 | 30 | 10 | 30 | 10 | 30 | 60 | 60 | 300 | 60 |
| (minute) | | | | | | | | | | | | | | | |

After that, the gas in the firing furnace was replaced by a nitrogen atmosphere, and then the metal catalyst was taken out from the firing furnace.

### Examples 2 and 3 and Comparative Examples 1 to 8

Metal catalysts were obtained in the same manner as in Example 1 except that the mixture proportions of the lanthanum nitrate aqueous solution and the nickel nitrate aqueous solution were as expressed in Table 3.

Note that several drops of ethanol (1 to 5 drops) were added to the mixture solution in order to uniformly mix the carbon support in Example 1 and Comparative Example 8 among Examples 1 to 3 and Comparative Examples 1 to 8.

TABLE 3

| | | | | | Com- | Com- | Com- | Com- | Com- | Com- | Com- | Com- |
|---|---|---|---|---|---|---|---|---|---|---|---|---|
| Example No./ | | | | | parative | parative | parative | parative | parative | parative | parative | parative |
| Comparative | | Exam- | Exam- | Exam- | Exam- | Exam- | Exam- | Exam- | Exam- | Exam- | Exam- | Exam- |
| Example No. | | ple 1 | ple 2 | ple 3 | ple 1 | ple 2 | ple 3 | ple 4 | ple 5 | ple 6 | ple 7 | ple 8 |
| mixture | lantha- | 1.874 | 3.345 | 4.531 | 5.508 | 6.326 | 7.021 | 7.619 | 8.139 | 8.595 | 8.999 | — |
| amount | num | | | | | | | | | | | |
| (mL) | nitrate | | | | | | | | | | | |
| | aqueous | | | | | | | | | | | |
| | solution | | | | | | | | | | | |
| | nickel | 8.994 | 7.136 | 5.639 | 4.406 | 3.374 | 2.496 | 1.742 | 1.085 | 0.509 | — | 11.36 |
| | nitrate | | | | | | | | | | | |
| | aqueous | | | | | | | | | | | |
| | solution | | | | | | | | | | | |
| content | lantha- | 10 | 20 | 30 | 40 | 50 | 60 | 70 | 80 | 90 | 100 | 0 |
| propor- | num | | | | | | | | | | | |
| tion | nickel | 90 | 80 | 70 | 60 | 50 | 40 | 30 | 20 | 10 | 0 | 100 |
| (mol %) | | | | | | | | | | | | |

### (Evaluation)

Test pieces of the fuel side electrodes including the metal catalysts obtained by Examples and Comparative Examples were produced and their activities were measured.

### Production of Test Piece

First, 0.005 g of the metal catalyst in each of Examples and Comparative Examples, 4 mL of pure water, and 0.75 mL of 2-propanol were mixed and dispersed for 10 minutes in an ultrasonic disperser.

Next, a mixture solution of 0.23 mL of tetrahydrofurane and 20 μL of ionomer was added to the dispersion liquid, and dispersed for 10 minutes in an ultrasonic disperser.

After that, 40 μL of the obtained dispersion liquid was taken with a micropipette, and dropped onto an operation electrode for evaluating an electrochemical activity. Subsequently, the dispersion liquid was dried at room temperature for approximately one hour. Thus, the test piece of each of Examples and Comparative Examples was obtained.

### Measurement of Activity

An oxidation activity of hydrazine was evaluated using each test piece and a mixture liquid of 1M KOH and 1M hydrazine hydrate as the electrolyte solution.

The measurement conditions are as follows:

### (Measurement i (Before Endurance Test))

potential width: −0.13 V to 0.22 V (vs. reversible hydrogen electrode (RHE));
scan speed: 5 mV/second;
measurement temperature: 60° C.;
reference electrode: Zn/ZnO (0.43 V vs. RHE (60° C.)/1M KOH);
auxiliary electrode: Pt wire; and
number of cycles: 6 cycles.

### (Measurement ii (Endurance Test))

potential width: −0.13 V to 0.22 V (vs. reversible hydrogen electrode (RHE));
scan speed: 20 mV/second;
measurement temperature: 60° C.;
reference electrode: Zn/ZnO (0.43 V vs. RHE (60° C.)/1M KOH);
auxiliary electrode: Pt wire; and
number of cycles: 100 cycles.

### (Measurement iii (After Endurance Test))

potential width: −0.13 V to 0.22 V (vs. reversible hydrogen electrode (RHE));
scan speed: 5 mV/second;
measurement temperature: 60° C.;
reference electrode: Zn/ZnO (0.43 V vs. RHE (60° C.)/1M KOH);
auxiliary electrode: Pt wire; and
number of cycles: 6 cycles.

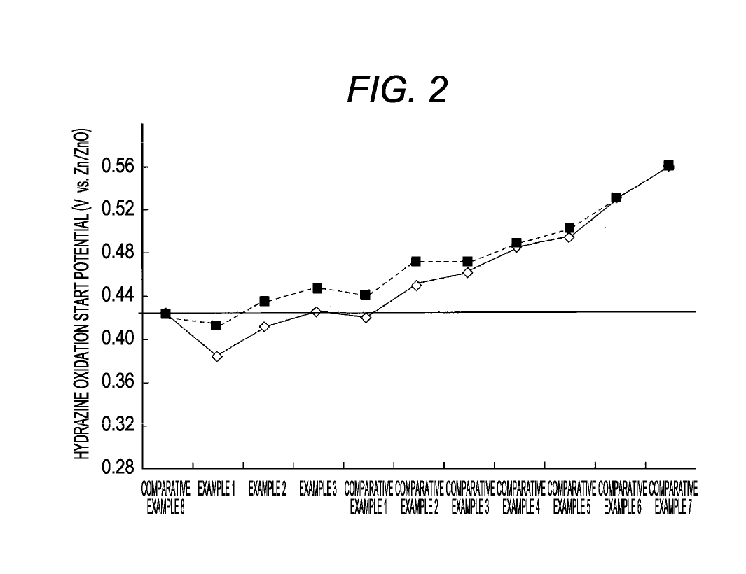

Results of evaluating the activities in the measurement i (before endurance test) and the measurement iii (after endurance test) are shown in FIG. 2.

Note that in FIG. 2, the results of the measurement i (before endurance test) are shown with a dashed line and the results of the measurement iii (after endurance test) are shown with a solid line.

Moreover, an evaluation in Comparative Example 8 (catalyst containing only nickel) is shown as a reference line.

As indicated in FIG. 2, the metal catalyst in each Example is lower in oxidation start potential than, and superior in power generation performance to the metal catalyst in each Comparative Example. In Comparative Examples 6 and 7, the results of evaluating the activities in the measurement i and the measurement iii were the same.

This application is based on Japanese Patent Application No. 2010-241273 filed with the Japan Patent Office on Oct. 27, 2010, the entire content of which is hereby incorporated by reference.

### DESCRIPTION OF REFERENCE SIGNS

2 FUEL SIDE ELECTRODE
3 OXYGEN SIDE ELECTRODE
4 ELECTROLYTE LAYER
S CELL FOR FUEL CELL

1. A fuel cell comprising an electrolyte layer, a fuel side electrode to which fuel is supplied, and an oxygen side electrode to which oxygen is supplied, the fuel side electrode and the oxygen side electrode being disposed to face each other with the electrolyte layer interposed therebetween, wherein
the electrolyte layer is an anion exchange membrane;
the fuel includes a compound containing at least hydrogen and nitrogen;
the fuel side electrode contains lanthanum and nickel; and
the fuel side electrode contains lanthanum at a proportion of 10 to 30 mol % relative to the total mole of lanthanum and nickel.

2. The fuel cell according to claim 1, wherein the fuel is hydrazines.
